(19) United States
(12) Patent Application Publication
(10) Pub. No.: US 2009/0230865 A1
(43) Pub. Date: Sep. 17, 2009

(54) High-Pressure Discharge Lamp with Discharge Vessel

(75) Inventor: Gotthard Schleicher, Wonneberg (DE)

Correspondence Address: OSRAM SYLVANIA INC, 100 ENDICOTT STREET, DANVERS, MA, 01923, US

(73) Assignee: PATENT-TREUHAND GESELLSCHAFT FUR ELEKTRISCHE GLUHLAMPEN MBH, MUNCHEN (DE)

(21) Appl. No.: 11/992,048

(22) PCT Filed: Sep. 13, 2006
(86) PCT No.: PCT/EP2006/066334

§ 371 Date: Mar. 14, 2008

(30) Foreign Application Priority Data
Sep. 16, 2005 (DE) 20 2005 014 660.9

(51) Int. Cl. H01J 61/06

(52) U.S. Cl. 313/629

(57) ABSTRACT

The invention relates to an electrode (1) of a high pressure discharge lamp with a heating device (3) housed in the head (2) in order to compensate for problems in dimmed operation.

### TECHNICAL FIELD

The invention is based on a high-pressure discharge lamp with a ceramic discharge vessel in accordance with the precharacterizing clause of claim 1. It concerns in particular metal-halide lamps, in particular for general lighting, or else sodium high-pressure lamps.

### PRIOR ART

DE-A-10 2004 020 397 has disclosed a method for dimming a high-pressure discharge lamp.

The book Betriebsgeräte und Schaltungen für elektrische Lampen [Control gear and circuits for electric lamps], C. H. Sturm and E. Klein, 1992, SAG (referred to below as Sturm) has also disclosed various possibilities for dimming high-pressure discharge lamps, see in particular page 235 and pages 296-297. However, with a reduced supply of electrical energy, the cooling of the electrodes and, under certain circumstances, also cooling of the discharge vessel is problematic. For these reasons, the dimming of high-pressure discharge lamps has until now not been very widely used at all. If dimming takes place at all, then this takes place in a very restricted range and possibly at the expense of a reduced life. A change in the emission spectrum can likewise be observed. This is based on the changed thermal conditions of the electrodes and of the entire discharge vessel.

### DESCRIPTION OF THE INVENTION

The object of the present invention is to provide a high-pressure discharge lamp in accordance with the precharacterizing clause of claim 1 which can be dimmed, in particular in a wide range, and which avoids in particular the disadvantages of the prior art.

This object is achieved by the characterizing features of claim 1. Particularly advantageous configurations are given in the dependent claims.

According to the invention, the cooling of the electrode is prevented by virtue of the fact that the lamp has an additional heat source added. This source can be fitted either internally or externally on the discharge vessel. In particular, the electrode geometry can be optimized in suitable fashion in order to allow the heating process to be coupled effectively.

The temperature of the electrodes can therefore be increased. If the supply of the heating energy is designed to be controllable, the dimming response is thereby positively assisted in the case of a dimmable lamp.

On the other hand, the technology can also be utilized for provided preheating of the electrodes, which improves the starting response of the lamp.

This preheating can be designed to be, for example, technically similar to the heating control of electronic ballasts for fluorescent lamps. One example is cited in DE-Az 102004044180.4 and in DE-Az 102004035122.8 and in DE-A 102 52 834, DE-A 102 52 836, DE-A 102 26 899, DE-A 101 40 723, DE-A 100 53 803 and DE-A 34 41 992.

The heating means is positioned on the inside or outside of the electrode. In principle, the heating power can be concentrated at a desired location via the variation of the resistivity, for example by suitable material selection, and the cross section of the electrode or a change in the cross-sectional area.

In particular metal-halide lamps and sodium high-pressure lamps are possible application fields.

### FIGURES

The invention will be explained in more detail below with reference to a plurality of exemplary embodiments. In the drawing:

FIG. 1 shows an electrode for a high-pressure discharge lamp with a heating apparatus on the inside;

FIGS. 2 to 3 show electrodes with a heating apparatus on the outside in various exemplary embodiments;

FIG. 4 shows a high-pressure discharge lamp with a head electrode;

FIG. 5 shows a further exemplary embodiment of an electrode;

FIG. 6 shows a discharge vessel of a high-pressure discharge lamp;

FIG. 7 shows a further exemplary embodiment of an electrode; and

FIG. 8 shows a further exemplary embodiment of a high-pressure discharge lamp.

### DESCRIPTION OF A PREFERRED EMBODIMENT

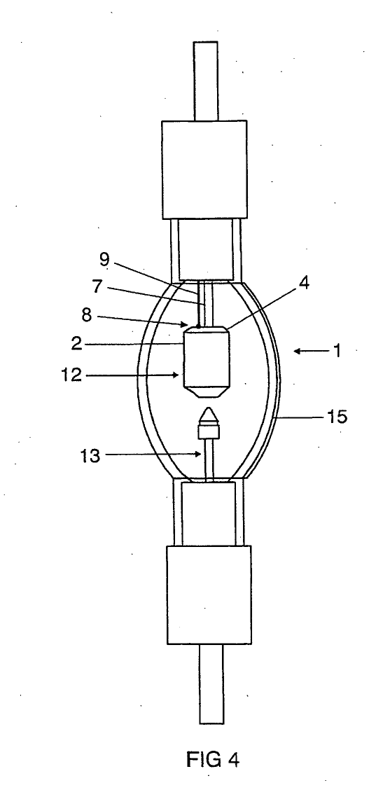

A basic circuit for an electronic ballast for a high-pressure discharge lamp is based, for example, on the embodiments in Sturm, page 217, FIG. 4.44.

An operating method can use a bipolar square-wave supply current. A short-term excess power can be impressed for example, for the purpose of stabilizing the commutation, the resulting power corresponding to the lamp rated power and, in the case of dimming, being below the rated power.

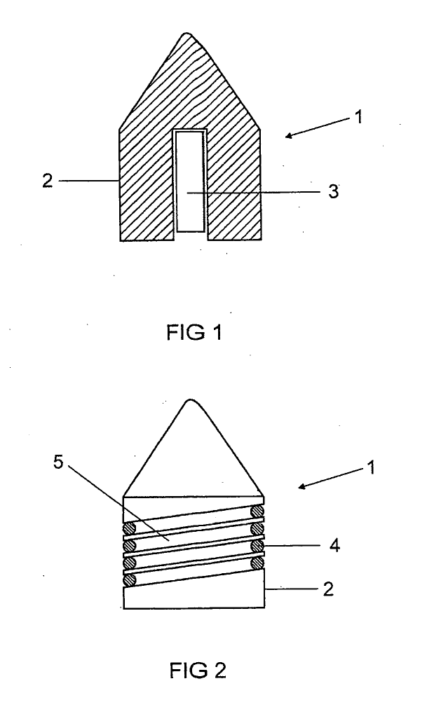

FIG. 1 shows a suitable electrode 1 for a metal-halide lamp, in which a heating cartridge 3, which is accommodated in the head 2 of the electrode, provides the heating. In this case, a contact of the heating means of the cartridge can be connected to the electrode.

FIG. 2 shows a head 2 of an electrode 1, in which the heating means is embedded in the form of a wire 4 in thread-like grooves 5 in the head 2. Again a contact can be connected to the electrode.

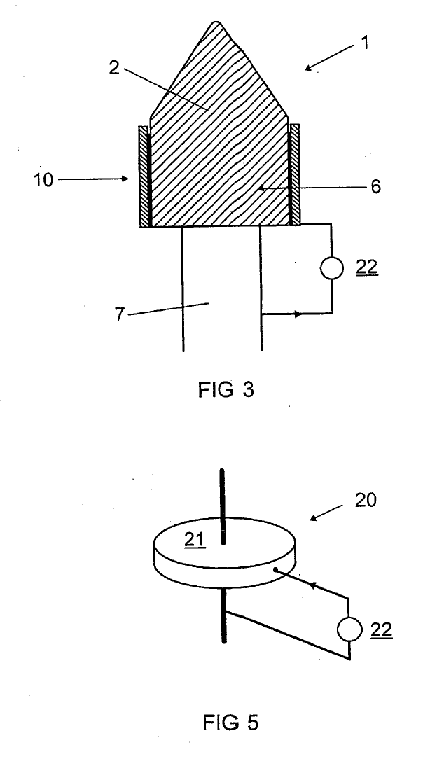

In FIG. 3, the heating means 10 is fitted on the outside to the electrode 1 on the rear part 6 of the head 2. The head 2 rests on a shaft 7. As a result of the high temperature loading prevailing there, the heating means is a conductive layer, in particular a conductive ceramic, preferably an electrically conductive cermet, as is known per se.

FIG. 4 shows a high-pressure discharge lamp with a head electrode. The lamp is a schematically illustrated mercury short-arc lamp. A discharge vessel 15 which is sealed at two ends contains an anode 12 and, opposite, a cathode 13. The lamp is operated at a power of 3400 W on a current of 148 A. The discharge vessel is filled with 1.4 bar of xenon and 2.5 mg of mercury per cm³. The anode 12 comprises a cylindrical shaft 7 and

a solid cylindrical head 2, which is positioned thereon and contains the heating means. Only the contact 9 is visible. The heating apparatus 8, as described in FIG. 1, is fitted laterally to the rear end 4 of the anode. Alternatively, another of the electrode arrangements described in the preceding figures with the heating apparatus in the lamp can be used.

Particularly suitable for dimming operation of metal-halide lamps with a low power, in particular 20 to 150 W, is the use of an acicular electrode 20, see FIG. 5. An electrically conductive disk 21 is fitted approximately centrally around said acicular electrode 20. This disk is heated electrically by means of a heat source 22. As a result of the increasing current density towards the electrode, the heating is the greatest there. This effect can be intensified by varying the disk thickness, in particular in the radial direction, or else by the continuous or stepwise tapering of the disk towards the center. The disk preferably consists of molybdenum, an alloy of molybdenum, or an electrically conductive cermet. A lighting unit in addition also comprises an electrical circuit, which makes a dimming operation possible, preferably in a wide range of between 10 and 100%.

The disk can have a central hole, through which the electrode is plugged. However, the disk can also be configured without a hole. In this case, the electrode comprises two parts, which are fixed at the top and the bottom on the disk.

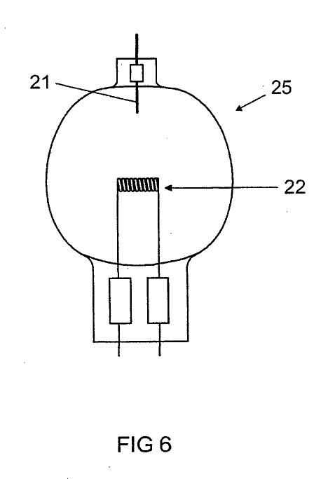

FIG. 6 shows a typical discharge vessel 25 for high-pressure discharge lamps with an acicular electrode 21 and a mating electrode 22 similar to as is known for low-pressure discharge lamps.

The filling of the discharge vessel, in addition to an inert starting gas, for example argon, comprises mercury and additives of metal halides. The use of a metal-halide filling without mercury, for example, is also possible, a high pressure being selected for the starting gas xenon.

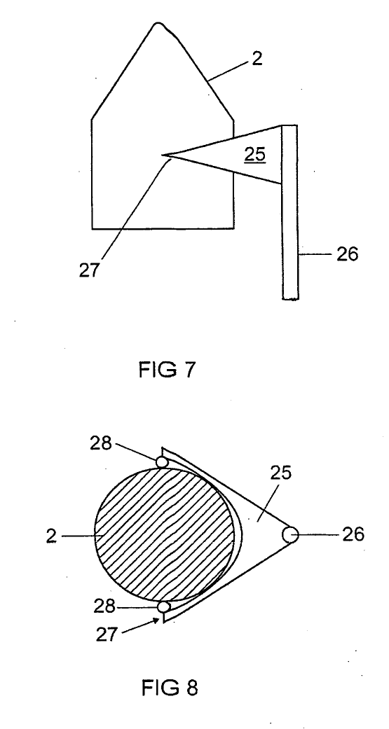

FIG. 7 finally shows the head 2 of an electrode, in which the heating contact is produced by means of a part 25, which tapers in dovetail fashion and is fixed to a contact 26. As a result of the tapering of the part, the heating power is concentrated on the tip area 27. In this case, the two heating poles 28, which produce the contact to the head 2, should be manufactured from a highly thermally resistant material.

FIG. 8 is a schematic illustration of a high-pressure discharge lamp 1. A discharge vessel 5 which is sealed at two ends contains an anode 2 and, opposite, a cathode 3. The lamp is operated at a power of 3400 W. The discharge vessel is filled with 1.4 bar of xenon and 2.5 mg of mercury per cm³. The anode comprises a cylindrical shaft 6 and a solid cylindrical head 7 attached thereto.

1. A high-pressure discharge lamp with a discharge vessel (4), which contains electrodes and a filling, characterized in that at least one of the electrodes has an associated heating apparatus, which is arranged within the discharge vessel.

2. The high-pressure discharge lamp as claimed in claim 1, characterized in that the heated electrode has a shaft with a head attached thereto.

3. The high-pressure discharge lamp as claimed in claim 2, characterized in that the heating apparatus is a heating cartridge, which is introduced in the head of the electrode.

4. The high-pressure discharge lamp as claimed in claim 2, characterized in that the heating apparatus is fixed on the outside on the head of the electrode.

5. The high-pressure discharge lamp as claimed in claim 4, characterized in that the heating apparatus is wound in the form of a wire around part of the electrode head.

6. The high-pressure discharge lamp as claimed in claim 4, characterized in that the heating apparatus is applied as a conductive layer to part of the electrode head.

7. The high-pressure discharge lamp as claimed in claim 1, characterized in that the heated electrode is an acicular electrode.

8. The high-pressure discharge lamp as claimed in claim 7, characterized in that the heating apparatus is a conductive disk, which is in particular plugged onto the electrode.

9. The high-pressure discharge lamp as claimed in claim 1, characterized in that electrical contact is made with the heating apparatus of the heated electrode by means of a wire which is tapered to a point.

10. The high-pressure discharge lamp as claimed in claim 1, characterized in that it is suitable for dimming operation.

11. A lighting unit with a high-pressure discharge lamp as claimed in claim 10 and an electrical circuit, which makes dimming operation possible.
